(19) United States
(12) Patent Application Publication
(10) Pub. No.: US 2022/0081940 A1
(43) Pub. Date: Mar. 17, 2022

(54) LOCKING TABS

(71) Applicant: Hewlett-Packard Development Company, L.P., Spring, TX (US)

(72) Inventors: David Quijano, Spring, TX (US); Paul Roberto Lalinde, Spring, TX (US)

(73) Assignee: Hewlett-Packard Development Company, L.P., Spring, TX (US)

(21) Appl. No.: 17/419,519

(22) PCT Filed: May 23, 2019
(86) PCT No.: PCT/US2019/033681

§ 371 Date: Jun. 29, 2021

(51) Int. Cl. E05B 67/38; G06F 1/18

(52) U.S. Cl. CPC E05B 67/383; E05B 73/0082; G06F 1/181

(57) ABSTRACT

An example computing device chassis may include a fastener to seal the computing device chassis and a tab attached to an external surface of the computing device chassis and slidable over the external surface of the computing device chassis between a first position, exposing the fastener beneath the tab and a second position, obstructing access to the fastener beneath the tab and exposing a lock-engaging portion of the tab, wherein engagement of the lock-engaging portion of the tab with a locking mechanism blocks the tab from returning to the first position.

### BACKGROUND

Computing devices may be utilized in a variety of settings and may be utilized to handle a variety of data. A computing device may be housed in an enclosure such as a computing device chassis. Computing devices and their data may be secured. For example, computing devices and their data may be physically secured utilizing a lock.

### BRIEF DESCRIPTION OF THE DRAWINGS

FIG. 1A illustrates an example of a computing device chassis having an example tab consistent with the present disclosure.

FIG. 1B illustrates an example of a computing device chassis having an example tab consistent with the present disclosure.

FIG. 1C illustrates an example of a computing device chassis having an example tab consistent with the present disclosure.

FIG. 1D illustrates an example of a computing device chassis having an example tab consistent with the present disclosure.

FIG. 2 illustrates an example of an exploded view of a portion of a computing device chassis having an example tab consistent with the present disclosure.

FIG. 3A illustrates an example of a partially exploded view of a portion of a system having an example tab consistent with the present disclosure.

FIG. 3B illustrates an example of a partially exploded view of a portion of a system consistent having an example tab with the present disclosure.

FIG. 3C illustrates an example of a partially exploded view of a portion of a system having an example tab consistent with the present disclosure.

### DETAILED DESCRIPTION

A computing device may include a laptop, a personal computing (PC) desktop, a server, a tablet, a smart phone, a smart accessory, a smart appliance, an internet-of-things device, a wearable computer, etc. The computing device may include computational components. Computational components may include components of the computing device that may be utilized to process and/or manipulate data (e.g., a processor, a memory, stored instructions executable by the processor to carry out functionalities, etc.).

The constituent computational components of the computing device may reside at the interior of a physical container. For example, the computational components of a computing device may reside in a computing device chassis. A computing device chassis may include an enclosure for containing the computational components of the computing device.

The computing device chassis may have a variety of form factors. For example, the computing device chassis may include a clamshell laptop form factor, a tower desktop form factor, a cabinet form factor, a server rack form factor, a case form factor, a body of the computing device form factor, a housing form factor, a blade casing form factor, a blade enclosure form factor, etc. That is, the computing device chassis may include an enclosure of any form factor that is designed to enclose at least a portion of the computational components of at least one computing device.

Computing devices are utilized in a variety of environments to perform a variety of computational tasks. In some examples, computing devices may be stored and/or utilized in varied public, private, industrial, military, retail, corporate, and other environments. In such environments, the computing devices and the data that they handle may be vulnerable to theft, improper access, misuse, damage, and/or destruction.

As such, computing device chassis that house the computational components and/or data may incorporate security measures to prevent theft, improper access, misuse, damage, and/or destruction of the computational components and/or data in the computing device chassis. For example, some laptop chassis may include a universal security slot (USS) or Kensington security slot (K-slot) including a small metal reinforced hole in the computing device chassis where a lock can be inserted into the chassis and locked into engagement with the hole. The lock may then be tethered to a heavy object such as a desk to prevent removal of the computing device chassis from the immediate area. However, the USS or K-slot may not prevent a nefarious actor from accessing the internals of the computing device chassis to steal, improperly access, misuse, damage, and/or destroy the computational components and/or the data enclosed therein.

Further, the security slots may introduce an opening into the interior of the computing device chassis. As such, the computational components within the computing device chassis may be exposed to dust, water, elements, foreign objects, and/or other contaminants that may enter the interior of the chassis through the opening. This may render the computing device chassis less rugged and more vulnerable to damage in environments where such contaminants exist. As such, computing device chassis with security slots may not meet rigorous standards, such as military contract specifications and/or industrial contract specifications for weather and/or water proofing. That is, in decreasing exposure of the computing device to theft, the security slots may increase exposure of the computational components to damaging contaminants,

Various gaskets and seals may be introduced around the security openings to try to limit contamination. However, gaskets and seals may not provide an impregnable barrier. Additionally, such gaskets and seals may represent a maintenance burden and potential failure point. For example, the same contaminants that may damage the computational components inside the computing device chassis may lead to corrosion or breaking down of the gasket material. Further, repeated use of the gasket or seal may lead to a mechanical erosion of the gasket or seal. As such, even with gaskets and seals, the security slot solution may represent potential failure points for the computing device chassis and may cause the computing device chassis with security slots to fail to meet rigorous standards.

In another example of a security mechanism, a desktop chassis may include a sheet metal tab protruding from an access cover portion of the chassis and a sheet metal tab protruding from a base portion of the chassis. The two protruding sheet metal tabs may be tied together by a padlock shank to block access to the interior of the computing device chassis. However, the protruding sheet metal tabs may not prevent the desktop chassis from being stolen and may be easily bent or broken allowing entrance into the computing device chassis with relatively little effort or force.

In addition, the protruding metal tabs may pose a snag risk even when they are not in use. That is, in environments where people and/or machinery may be handling and/or passing in close proximity to the computing device chassis, protrusions may be inadvertently snagged by a passer-by resulting in inadvertent shock, damage, and movement of the computing device chassis and its computational components. Further, snagging on the protruding metal tabs may damage the tabs, the people and/or machinery contacting them, and/or even other computing device chasses.

Moreover, modern aesthetics may include sleek, smooth, and seamless designs. As such, computing device chassis may be designed to have such an appearance. Protruding tabs may disrupt the aesthetics of the computing device chassis.

Additionally, both security slots and protruding sheet metal tabs may be visually evident features of a computing device chassis. That is, such security mechanisms may visually indicate or draw attention to the location of the security mechanism and, consequently, where the mechanism may be challenged. The visibility of the security measures may call attention to how unauthorized access to the computing device chassis may be gained. That is, such mechanisms do not obfuscate a means of entry to the interior of the computing device chassis.

In contrast, examples consistent with the present disclosure may include a locking tab mechanism that may be utilized to prevent theft of and/or unpermitted access into a computing device chassis without introducing openings into a computing device chassis, without utilizing structurally weak protrusions that pose a snag risk and destroy the aesthetics of the computing device chassis when not in use, and without revealing how the internal portion of the computing device chassis may be accessed. For example, examples consistent with the present disclosure may include computing device chassis sealed by a fastener and a tab attached to an external surface of the computing device chassis and slidable over the external surface of the computing device chassis. The tab may be slidable between a first position, exposing the fastener beneath the tab and a second position, obstructing access to the fastener beneath the tab and exposing a lock-engaging portion of the tab, wherein engagement of the lock-engaging portion of the tab with a locking mechanism blocks the tab from returning to the first position.

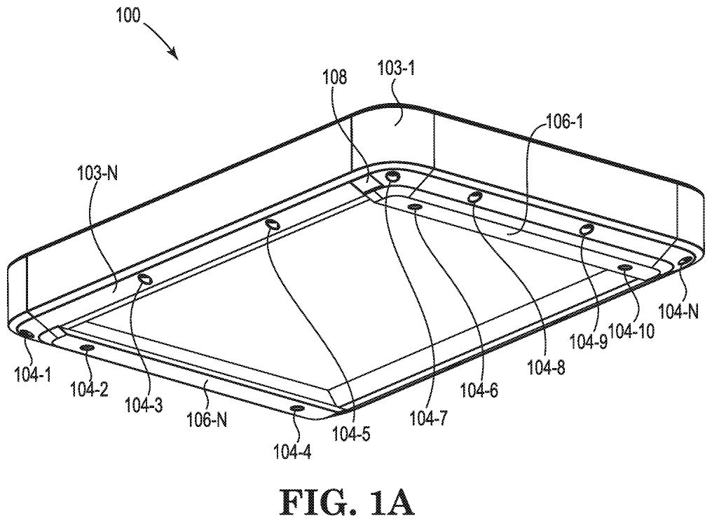

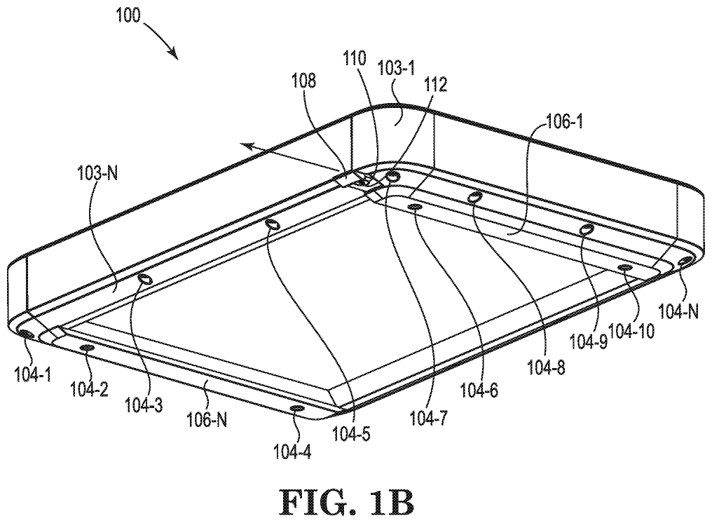

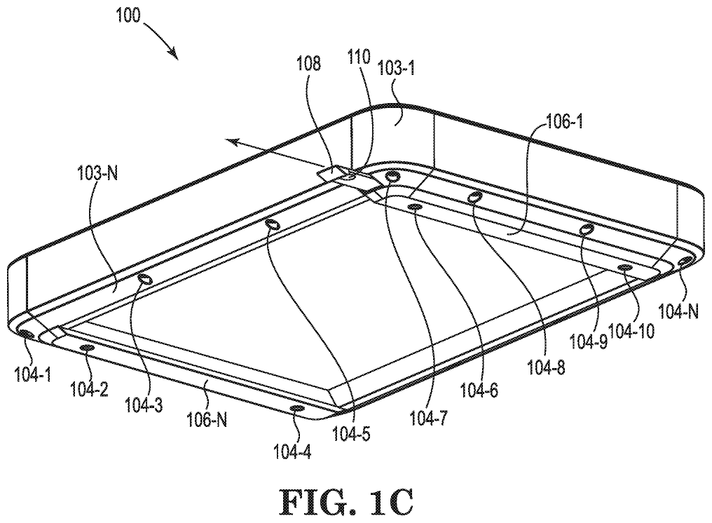

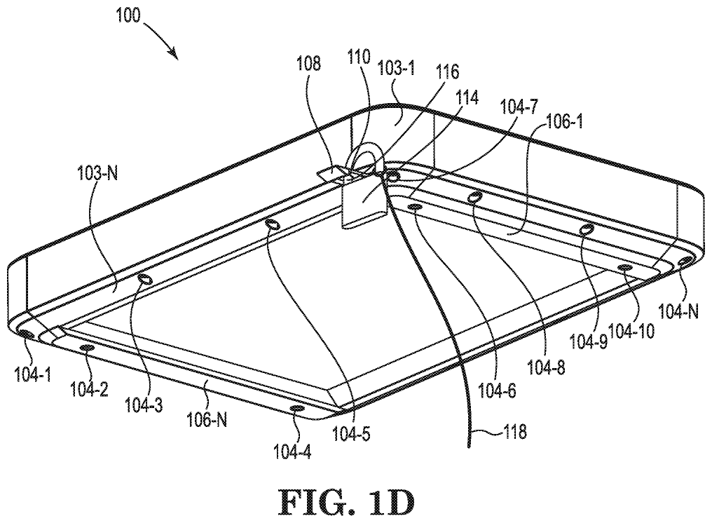

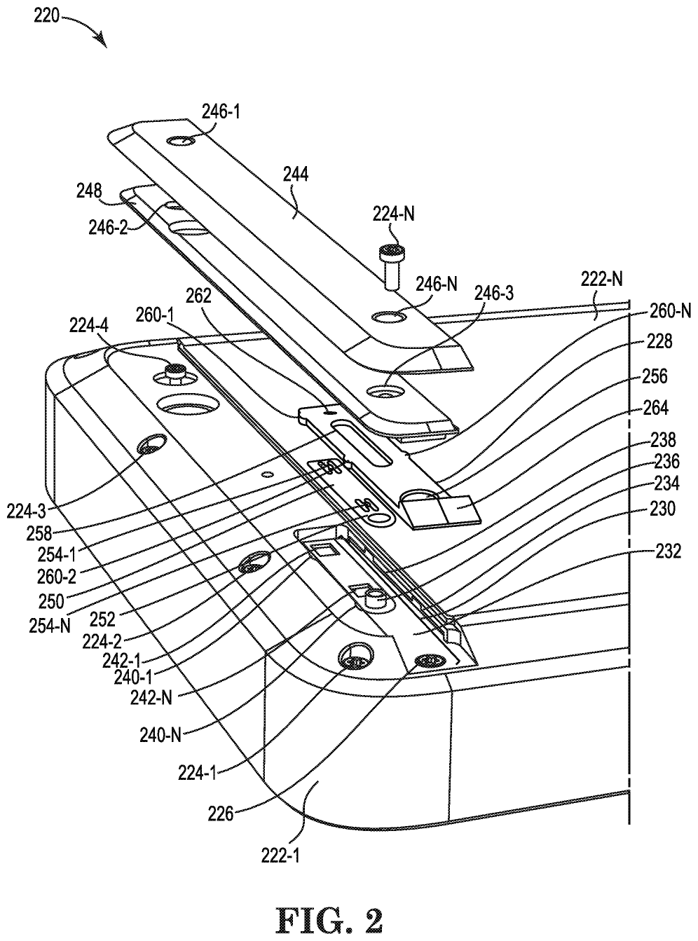

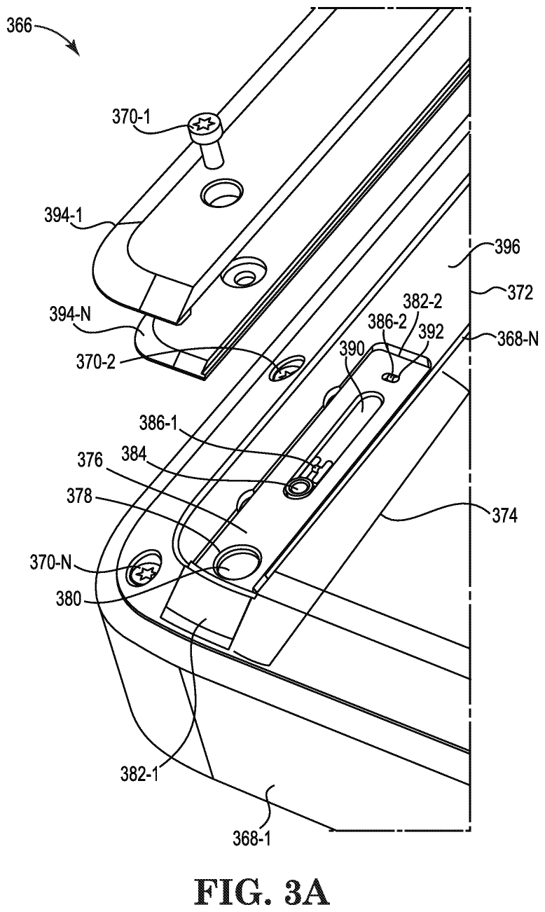

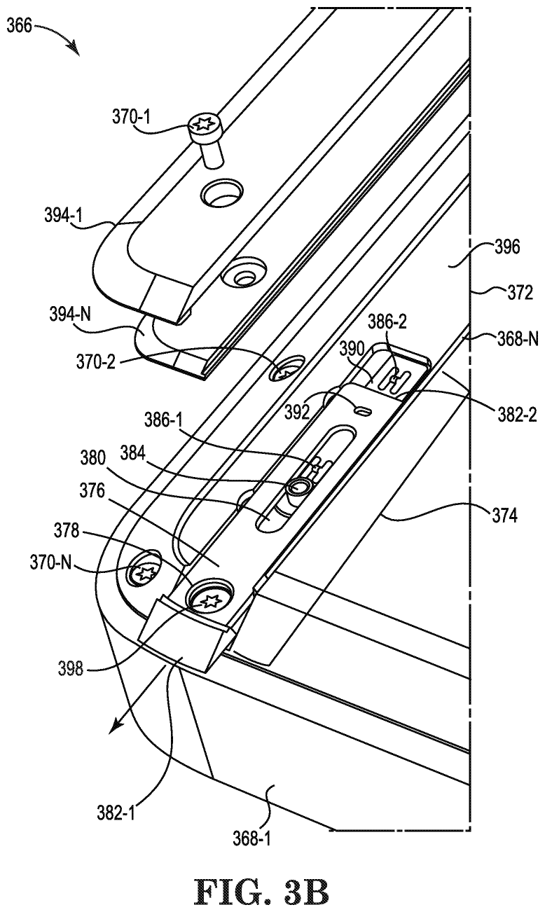

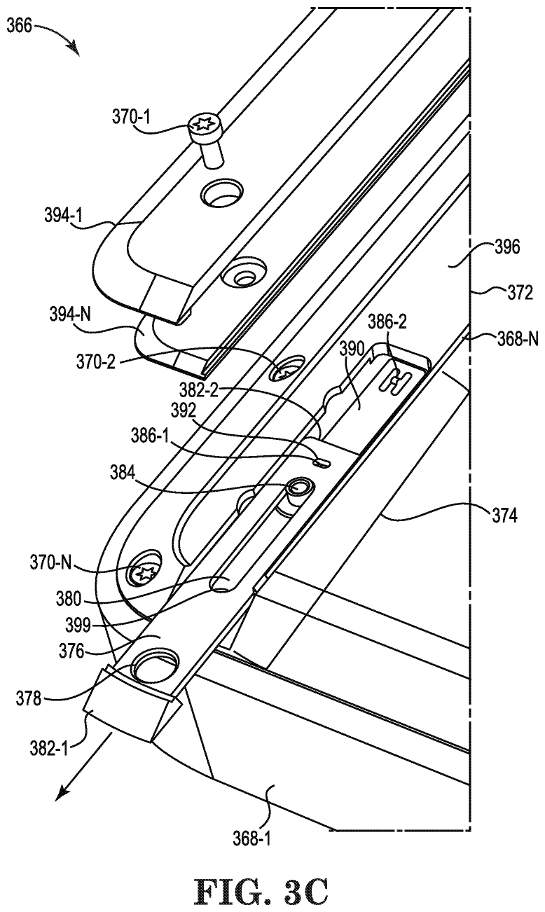

FIG. 1A illustrates an example of a computing device chassis 100 having an example tab 108 consistent with the present disclosure wherein the tab 108 is disposed in a third position. FIGS. 1A-1D may illustrate examples of the computing device chassis 100 with its constituent components in different positions or orientations. FIGS. 1A-1D may incorporate components from and/or have their illustrated components incorporated in the computing device chassis 220 of FIG. 2 and/or system 366 of FIGS. 3A-30.

The computing device chassis 100 may include an enclosure within which computational components may be housed. Although computing device chassis 100 is illustrated as a particular form factor, the form factor is not so limited and the mechanisms discussed herein are applicable to a wide array of chassis and other containers.

The computing device chassis 100 may include an industrial PC chassis. The computing device chassis 100 may, when assembled, be a sealed and fanless PC chassis that is weatherproof and waterproof. The computing device chassis 100 may meet, among other standards, United States Military Standard MIL-STD-810 for thermal shock, two-meter drop resistance, corrosion resistance, dust ingress, etc. The computing device chassis 100 may meet, among other standards, the International Protection Marking, IEC standard IP65 for water spray ingress. The computing device chassis 100 may be constructed from lightweight, corrosion resistant, structurally strong materials. For example, the computing device chassis 100 may be constructed from extruded aluminum panels. The panels may include input/output ports. The input/output ports may include conduits for connecting the computational components inside the computing device chassis 100 to external computing devices, a power source, and/or peripherals.

The computing device chassis 100 may be constructed from a plurality of portions 103-1 . . . 103-N joined together to form an enclosure for housing computational components. As described above, the portions 103-1 . . . 103-N may include extruded aluminum panels.

In examples, the computing device chassis 100 may include a first portion 103-1. The first portion 103-1 may include a top cover portion of the computing device chassis 100. The computing device chassis 100 may also include a second portion 103-N. The second portion 103-N may include a bottom cover or base plate portion of the computing device chassis 100.

A gasket, O-ring, or other seal may be present between and/or near a seam or seams of the various portions 103-1 . . . 103-N of the computing device chassis 100. For example, the first portion 103-1 and the second portion 103-N of the computing device chassis 100 may include a seal at their seam to exclude the external environment. As such, the plurality of portions 103-1...103-N of the computing device chassis 100 may form a sealed waterproof./dust proof internal environment within the computing device chassis 100 when the plurality of portions 103-1 . . . 103-N are joined together. The computing device chassis 100 may include any number of portions and each portion 103-1 . . . 103-N may include any number of sub-portions.

The plurality of portions 103-1 . . . 103-N may be attached to each other and held in a sealed configuration by fasteners 104-1 . . . 104-N. The fasteners 104-1 . . . 104-N may provide reversible attachment among the plurality of portions 103-1 . . . 103-N. For example, the fasteners 104-1 . . . 104-N may include a fastener, such as a machine screw, that may fasten the plurality of portions 103-1 . . . 103-N together to maintain a seal therebetween. As such, the computing device chassis 100 may be a sealed enclosure, sealing computational components off from the external environment. The computing device chassis 100 may remain sealed by virtue of the plurality of fasteners 104-1 . . . 104-N reversibly fixing the plurality of portions 103-1 . . . 103-N in a state of engagement. The plurality of fasteners 104-1 . . . 104-N may hold the plurality of portions 103-1 . . . 103-N together such that the plurality of portions 103-1 . . . 103-N may not be separated without removing the fasteners 104-1 . . . 104-N. Likewise, the plurality of fasteners 104-1 . . . 104-N may hold the plurality of portions 103-1 . . . 103-N together such that the computational components and/or other contents of the computing device chassis 100 may not be accessed from and/or exposed to the external environment without removing the fasteners 104-1 . . . 104-N.

In some examples, the fasteners 104-1 . . . 104-N may be inserted through the second portion 103-N of the computing device chassis 100. The fasteners 104-1 . . . 104-N may pass extend from the second portion 103-N of the computing device chassis 100 into a complementary structure of the first portion 103-1 of the computing device chassis 100. The heads of the fasteners 104-1 . . . 104-N may be visible and/or accessible on and/or through the second portion 103-N of the computing device chassis 100. As such, a user may disassemble or separate the first portion 103-1 and the second portion 103-N of the computing device chassis 100 by actuating the head of the fastener to unfasten the connection between the first portion 103-1 and the second portion 103-N.

However, the computing device chassis 100 may also include a hidden fastener (not visible in the view illustrated in FIG. 1A). The hidden fastener may be a fastener in addition to the visible fasteners 104-1 . . . 104-N. For example, the hidden fastener, along with the visible fasteners 104-1 . . . 104-N, may fasten the plurality of portions 103-1 . . . 103-N together. The hidden fastener may be visually obscured and/or physically obstructed. The existence and/or location of a hidden fastener may not be apparent by a visual inspection of the computing device chassis 100 in the orientation illustrated in FIG. 1A. As such, the hidden fastener may be visually and/or physically obstructed from access in the orientation illustrated in FIG. 1A.

The hidden fastener may represent a first layer of security of the computing device chassis 100. As described above, in order to access the computational components and/or other contents sealed within the interior of the computing device chassis 100, the fasteners 104-1 . . . 104-N may need to be removed. Additionally, the hidden fastener may also need to be removed in order to access the computational components and/or other contents sealed within the interior of the computing device chassis 100. That is, the plurality of portions 103-1 . . . 103-N of the computing device chassis 100 may remain fixed together in a sealed orientation until fasteners 104-1 . . . 104-N and the hidden fastener are removed or otherwise unfastened.

An unauthorized user may be unaware of the location and/or existence of the hidden fastener. A visual inspection of the computing device chassis 100 in the orientation depicted in FIG. 1A may not resolve such ignorance. Even if, in such examples, the unauthorized user was to remove or otherwise unfasten the visible and unobstructed fasteners 104-1 . . . 104-N, he would find himself unable to open computing device chassis 100 and/or access its interior. The confusion created by the hidden fastener may cause the unauthorized user to abandon their unauthorized attempt to access the interior of the computing device chassis 100,

The existence of the hidden fastener may be kept a secret among authorized users. However, even with knowledge of the existence of the hidden fastener and its location, additional security layers may prevent unauthorized access in the manner described below.

The computing device chassis 100 may include a raised structure 106-1 . . . 106-N. The raised structure 106-1 . . . 106-N may include a structure that is raised relative to an external surface of the second portion 103-N of the computing device chassis 100. The raised structure 106-1 . . . 106-N may be a foot or pedestal portion of the computing device chassis 100. For example, the raised structure 106-1 . . . 106-N may protrude out from the second portion 103-N and may act as a foot for the computing device chassis 100 to rest on when the computing device chassis 100 is being stored or operated. As such, the second portion 103-N may be a bottom of the computing device chassis 100 and the raised structures 106-1 . . . 106-N may be the feet attached to the bottom of the computing device chassis 100.

The raised structure 106-1 . . . 106-N may be a separate structure that is attached to the second portion 103-N of the computing device chassis 100. The raised structure 106-1 . . . 106-N may be attached to the external surface of the second portion 103-N utilizing fasteners (e.g., 104-2, 104-4, 104-6, and 104-10). In addition, a portion of the raised structure 106-1 . . . 106-N may be fixed to the external surface of the second portion 103-N utilizing a permanent adhesive. That is, the raised structure 106-1 . . . 106-N may be adhered to the external surface of the second portion 103-N of the computing device chassis 100 such that the raised structure 106-1 . . . 106-N cannot be readily removed without causing damage to the raised structure 106-1 . . . 106-N and/or the second portion 103-N of the computing device chassis 100.

A cavity, not visible in the orientation depicted in FIG. 1A, may exist between the raised structure 106-1 and the external surface of the second portion 103-N of the computing device chassis 100. That is, a hollow cavity may be located between an internal surface of the raised structure 106-1 and the external surface of the second portion 103-N of the computing device chassis 100. This cavity may be discontinuous with the sealed interior of the computing device chassis 100. That is, the wall of the second portion 103-N may separate the cavity from the interior of the computing device chassis 100. As such, water, dust, debris, contaminates, foreign objects, etc. that may be introduced into the cavity may be physically separated from and unable to enter the interior of the computing device chassis 100 as no communication between the two spaces may exist.

The cavity may be occupied by a tab 108. The tab 108 may have an elongate geometry that fits within the cavity. The tab 108 may be constructed of a heavy gauge sheet metal that is resistant to bending and breaking. The tab 108 may terminate at a first end. For example, a first terminus of the tab 108 may have a geometry that is dimensioned to nest within and integrate flush to the second portion 103-N of the computing device chassis 100 and/or the raised structure 106-1. That is, the tab 108 may terminate at a wedge shaped first terminus that, when fully nested in the cavity (as illustrated in FIG. 1A), provides a continuous flush appearance with the second portion 103-N of the computing device chassis 100 and/or the raised structure 106-1. As such, the first terminus of the tab 108 may blend in and appear as a continuous extension of the second portion 103-N of the computing device chassis 100 and/or the raised structure 106-1. Likewise, when fully nested in the cavity, the tab 108 may not protrude from the second portion 103-N of the computing device chassis 100 and/or the raised structure 106-1. As such, the tab 108, when fully nested in the cavity, may not pose a snag risk or disrupt the aesthetics of the computing device chassis 100.

The above described hidden fastener may be hidden and/or located underneath the tab 108. That is, the hidden fastener may be located at and/or through the external surface of the second portion 103-N of the computing device chassis 100 at a location that is under the tab 108 and/or within the cavity. In an example, when fully nested, the first terminus of the tab 108 may cover the hidden fastener. As such, the hidden fastener may be physically and/or visually obstructed by the first terminus of the tab 108. The hidden fastener may not be visible to and/or accessible for manipulation by a user when the tab 108 is fully nested in the cavity.

The tab 108 may be attached to the external surface of the second portion 103-N of the computing device chassis 100 and/or the raised structure 106-1 as described in greater detail below. For example, the tab 108 may be attached to the external surface of the second portion 103-N and/or the raised structure 106-1 by a retaining rail and/or a stop that prevents the tab 108 from being fully removed from the cavity.

However, the tab 108 may be slidable. For example, the tab 108 may be slidable over the external surface of the second portion 103-N of the computing device chassis 100 and/or slidable under the internal surface of the raised structure 106-1. For example, the tab 108 may be slidable between the external surface of the second portion 103-N of the computing device chassis 100 and/or the internal surface of the raised structure 106-1. The tab 108 may be slidable within the cavity between the external surface of the second portion 103-N of the computing device chassis 100 and/or the internal surface of the raised structure 106-1.

The tab 108 may be slidable between a plurality of positions. For example, the tab 108 may travel along an axis running parallel to the plane of the external surface of the second portion 103-N of the computing device chassis 100. As such, the tab 108 may slide along the axis further into the cavity until a stop is reached, out of the cavity until a stop is reached, and to a plurality of positions in between. For example, the tab 108 may be slidable within the cavity by manually pushing and pulling the tab 108 into the various positions. Alternatively, the computing device chassis 100 may incorporate a push-push-to-open mechanism within the cavity. For example, a user may be able to push a tab 108 to a position deeper within the cavity to engage a catch and then push the tab 108 in the same direction again to actuate a spring mechanism in the push-push-to-open mechanism that may cause the tab 108 to be popped out to another position that is shallower in the cavity. That is, the computing device chassis 100 may utilize a push-push-to-open mechanism to rapidly pop out and/or transition the tab 108 to various positions.

The tab 108 may be slidable between a first position, a second position, and a third position. Each of the first, second, and third positions may be characterized by the depth of the tab 108 within the cavity and/or the portion of the tab 108 exposed outside of the cavity. The hidden fastener may remain hidden and/or obstructed by the tab 108 unless the tab 108 is in a first position, described in greater detail below. The first position may be an intermediate position of travel from the second position to the third position and visa versa.

In FIG. 1A, the tab 108 is illustrated in the third position. In the third position, the tab 108 may be fully recessed within the cavity. As used herein, fully recessed within the cavity may include examples where the tab 108 has reached a stop or detent designed to demarcate and/or limit a furthest insertion of the tab 108 into the cavity.

In the third position, as described above, the tab 108 may be fully nested in the cavity. When fully nested, a first terminus of the tab 108 may provide a continuous flush appearance with the second portion 103-N of the computing device chassis 100 and/or the raised structure 106-1. That is, in the third position, the tab 108 may blend in and appear as a continuous extension of the second portion 103-N of the computing device chassis 100 and/or the raised structure 106-1. Likewise, when fully nested in the cavity, in the third position, the tab 108 may not protrude from the second portion 103-N of the computing device chassis 100 and/or the raised structure 106-1. As such, when fully nested in the cavity, in the third position, the tab 108 may not pose a snag risk or disrupt the aesthetics of the computing device chassis 100.

At each position, including the third position, the tab 108 may encounter a detent to catch the tab 108 and hold it in the corresponding position. For example, the tab 108 may engage a detent within the cavity when the tab 108 is slid to the third position. The tab 108 may be held in or biased to the third position by the detent within the cavity. For example, the detent may engage the tab 108 when it arrives at the third position and may exert a biasing force to retain the tab 108 at the third position.

To re-initiate travel of the tab 108 after engagement by the detent in the third position, a user may pry and/or pull on the first terminus of the tab 108. For example, the user may pull on the tab 108 with enough force to overcome the biasing force of the detent and slide the tab 108 out of the cavity away from the third position.

Alternatively, or additionally, the user may press the tab 108 further into the cavity to actuate a spring mechanism (e.g., push-push-to-open) that will initiate a mechanical response to cause the tab 108 to overcome the biasing force of the detent, pass over the detent into a state of free slide-ability, and/or be ejected from the cavity to a detent at the first position. As described above and below, the tab 108 may be slidable to a first and a second position from the illustrated third position.

In the third position, the hidden fastener may be visually hidden and/or obstructed. For example, the hidden fastened may not be visible when the tab 108 is in the third position. Further, a visual inspection of the computing device chassis 100 with the tab 108 in the third position may not reveal that the tab 108 exists or that it has any functionality or slide-ability. That is, both the tab 108 and the hidden fastener may be hidden when the tab 108 is in the third position.

FIG. 1B illustrates an example of a computing device chassis 100 having an example tab 108 consistent with the present disclosure wherein the tab 108 is disposed in the first position. The first position illustrated in FIG. 1B may be an intermediate position of tab 108 travel located between the third position illustrated in FIG. 1A and the second position illustrated in FIG. 1C. FIG. 1B includes an arrow indicating a direction of travel of the tab 108 from FIG. 1A to FIG. 1B.

The computing device chassis 100 may include a hidden fastener 112. The hidden fastener 112 may fasten together the plurality of portions 103-1 . . . 103-N, thereby sealing the computing device chassis 100. The hidden fastener 112 may be obstructed from view and obstructed from physical manipulation when the tab 108 is in the third position, the second position, or any position other than the first position illustrated in FIG, 1B. That is, a portion of the tab 108 may cover the hidden fastener 112 when it is slid into a position other than the first position.

However, when the tab 108 is in the first position as illustrated in FIG. 1B, the hidden fastener 112 may be visible and accessible for manipulation (e.g,, unfastening, unscrewing, etc.). For example, the tab 108 may include an aperture 110. The aperture 110 may include a hole or window through the body of the tab 108 that allows for an object to pass through the tab 108. The aperture 110 may be approximately the size of or slightly larger than a widest portion of the hidden fastener 112. As such, the hidden fastener 112 may be removed through or inserted through the aperture 110.

In the first position, the tab 108 may be slid into a position where the aperture 110 is aligned over the head of the hidden fastener 112. As such, the hidden fastener 112 may become visible through the aperture 110 when the tab 108 is slid to the first position. That is, the hidden fastener 112 visible on the face of the external surface of the second portion 103-N of the computing device chassis 100 may be visible through and/or within the aperture 110 when the tab 108 is in the first position.

The aperture 110 may have a fixed position on the elongate body of the tab 108. However, since the tab 108 itself may be slidable over the external surface of the second portion 103-N of the computing device chassis 100, the aperture 110 may be slid into a variety of positions over the external surface of the second portion 103-N of the computing device chassis 100.

When the tab 108 is slid into a position where its aperture 110 is aligned over the hidden fastener 112, a user may insert a tool, such as a screwdriver, through the aperture 110 of the tab 108 to engage the hidden fastener 112 and unfasten or refasten the hidden fastener 112. The hidden fastener 112 may engage the first portion 103-1 of the computing device chassis 100 through the external surface of the second portion 103-N of the computing device chassis 100. Therefore, the hidden fastener 112 may hold the first portion 103-1 of the computing device chassis 100 and the second portion 103-N of the computing device chassis 100 together when fastened.

As such, when the hidden fastener 112 and the non-hidden fasteners 104-1 . . . 104-N are unfastened, the plurality of portions 103-1 . . . 103-N of the computing device chassis 100 may be separated and the contents of the interior of the computing device chassis 100 may be accessed. However, without knowledge of the existence and/or location of the hidden fastener 112, knowledge of the existence and/or location of the tab 108, and/or knowledge of the slide-ability of the tab 108 to the first position, a user may not access the internal contents of the computing device chassis 100, regardless of how many of the visible fasteners 104-1 . . . 104-N they unfasten.

In the first position, the tab 108 may not be fully nested within the cavity. The tab 108 may partially protrude from the cavity. For example, a first terminus of the tab 108 may protrude outside of the cavity and may even protrude outside of the outer perimeter of the second portion 103-N of the computing device chassis 100. For example, the terminus having the complementary geometry to visually blend the tab 108 into and sit flush with the geometry of the second portion 103-N and the raised structure 106-1 may protrude outside of the cavity and the outer perimeter of the second portion 103-N of the computing device chassis 100 when the tab 108 is in the first position.

The first position may be a disassembly, service, or access position and may not be a typical configuration for the computing device chassis 100. That is, while the terminus of the tab 108 may present a snag risk in the first position, the risk of such a snag occurring while the tab 108 is in the first position may be de minimis since the tab 108 may be in the first position irregularly. For example, the tab 108 may be in the first position during a relatively uncommon service occurrence and not during regular use of the computing device.

Further, when in the third position illustrated in FIG. 1A, the first terminus of the tab 108 may block water, dust, debris, contaminates, foreign objects, etc. from entering the cavity. However, when the tab 108 is in the first position illustrated in FIG. 1B it may be possible for water, dust, debris, contaminates, foreign objects, etc. to inadvertently enter the cavity. However, as described above, the cavity is a cavity between the external surface of the second portion 103-N of the computing device chassis 100 and the raised structure 106-1. This cavity is isolated from the internal portion of the computing device chassis 100. As such, the inadvertent introduction of water, dust, debris, contaminates, foreign objects, etc. into the cavity does not jeopardize the integrity of the seal of the plurality of portions 103-1 . . . 103-N of the computing device chassis 100. That is, contaminants in the cavity are not able to infiltrate the interior of the computing device chassis 100.

FIG. 1C illustrates an example of a computing device chassis 100 having an example tab 108 consistent with the present disclosure wherein the tab 108 is disposed in the second position. FIG. 10 includes an arrow indicating a direction of travel of the tab 108 from FIG. 1B to FIG. 10.

The tab 108 may include the aperture 110. The aperture 110 may include a hole through the body of the tab 108 that allows for an object to pass through or be viewed through the tab 108. As described above, the aperture 110 may be utilized as a window for access of the hidden fastener when the tab 108 is in the first position. However, in the second position the same aperture 110 may no longer be aligned over the hidden fastener. Instead, the aperture 110 may be located outside of the cavity and even outside the perimeter of the computing device chassis 100. As such, the aperture 110 may be utilized as a lock-engaging portion when the tab 108 is in the second position. For example, the aperture 110 may be approximately the same or slightly larger size and/or geometry of a lock shank, cable, or other locking mechanism. As such, a lock, cable, or other locking mechanism may be inserted through the aperture 110 of the tab 108 and engaged in a locked orientation when the tab 108 is in the second position.

In the second position, the tab 108 may be slid out of the cavity to a furthest distance of travel from the third position while still remaining engaged within the cavity. For example, the tab 108 may be extended a furthest distance out of the cavity that it can be extended before the tab 108 encounters a stop and/or a detent closest to the mouth of the cavity. For example, a plurality of stops and/or detents may be located within the cavity. In an example, a detent nearest the mouth of the cavity may hold or exert a biasing force to retain the tab 108 at the second position. To initiate travel of the tab 108 out of the second position, a user may press the tab 108 inward toward the cavity. The user may press with enough force to overcome the biasing force of the detent and pass the tab 108 over the detent into a state of free slide-ability.

In the second position, the tab 108 may protrude from the cavity. For example, the first terminus of the tab 108 may protrude outside of the cavity and may protrude outside of the outer perimeter of the second portion 103-N of the computing device chassis 100. Further, the aperture 110 may protrude outside of the cavity and may protrude outside of the perimeter of the first portion 103-1 of the computing device chassis 100. As such, the aperture 110 may be accessible and/or visible from a top of the computing device chassis 100 and/or a bottom of a computing device chassis 100.

The second position may be a locked or security position for the computing device chassis 100. That is, while the terminus of the tab 108 may present a snag risk in the second position, the tab 108 may be simultaneously functioning as a locking mechanism securing the computing device chassis 100 to a particular location. As such, the risk of such a snag occurring while the tab 108 is in the second position may be de minimis since the tab 108 may be in the second position during intentionally low-mobility uses of the computing device.

Again, when the tab 108 is in the second position illustrated in FIG. 1C it may be possible for water, dust, debris, contaminates, foreign objects, etc. to inadvertently enter the cavity. However, as described above, the cavity may be between the external surface of the second portion 103-N of the computing device chassis 100 and the raised structure 106-1. The cavity may be isolated from the internal portion of the computing device chassis 100. As such, the inadvertent introduction of water, dust, debris, contaminates, foreign objects, etc. into the cavity does not jeopardize the integrity of the seal of the plurality of portions 103-1 . . . 103-N of the computing device chassis 100. That is, water, dust, debris, contaminants, foreign objects, etc. may not be able to infiltrate the interior of the computing device chassis.

When in the second position, the tab 108 may visually and/or physically obstruct the hidden fastener. That is, the portion of the tab 108 body without the aperture 110 may cover up the hidden fastener when the tab 108 is in the second position. When in the second position, the hidden fastener may be inaccessible until the tab 108 is returned to the first position. That is, the hidden fastener may be hidden unless and until the tab 108 is slid back into the cavity to the first position. That is, the computing device chassis 100 may remain sealed and the plurality of portions 103-1 . . . 103-N of the computing device chassis 100 may remain fastened together until the tab 108 is slid back to the first position and the hidden fastener is removed through the aperture 110.

FIG. 1D illustrates an example of a computing device chassis 100 having an example tab 108 consistent with the present disclosure wherein the tab 108 is disposed in the second position. As described above, the aperture 110 may be utilized as a window to access the hidden fastener when the tab 108 is in the first position. However, the same aperture 110 may be utilized as a lock-engaging portion when the tab 108 is in the second position.

For example, the aperture 110 may have dimensions and/or a geometry that is complementary to a lock shank, cable, or other locking mechanism. As such, a shank 116 of a padlock 114, a cable 118, and/or other locking mechanism may be inserted through the aperture 110 in the tab 108 and engaged in a locked orientation. For example, a padlock 114 may be locked with its shank 116 positioned within and through aperture 110 and a cable 118 hooked around the shank 116 and fixed to a heavy stationary object. In such an example, the padlock 114 may be locked into and/or through the aperture 110. As such, the padlock 114 may not be able to be withdrawn from the aperture 110 until the padlock 114 is unlocked. Once the padlock 114 is unlocked, its shank 116 may be removed from the aperture 110.

As such, the tab 108 may be locked in the second position by an object inserted through the aperture 110. For example, the tab 108 may not be able to be slid further into the cavity while a padlock 114 is attached through the aperture 110. For example, the shank 116 and/or other portions of the padlock 114 may contact, interfere with, block, and/or otherwise obstruct the tab 108 from being pushed into the cavity toward the first and third positions. In an example, the shank 116 may contact the sidewall of the computing device chassis 100 if the tab 108 is pushed toward or into the cavity. As such, an object such as a padlock 114 shank 116 inserted through the aperture 110 may physically block the tab 108 from sliding within the cavity.

Again, the hidden fastener may be visually and/or physically obstructed by the tab 108 when the tab 108 is in the second position. Therefore, when locked in the second position, the tab 108 may be locked in place and preventing a user from being able to locate and/or remove the hidden fastener from the computing device chassis 100. As such, the internal contents of the computing device chassis 100 may be locked inside the computing device chassis 100 and sealed from access. That is, when the tab 108 is locked in the second position, the computing device chassis 100 may be locked in a sealed orientation. As such, the tab 108 may provide dual security layers of preventing the computing device chassis 100 from being removed from the area while simultaneously preventing the computing device chassis 100 from being opened up without possession of a key to a locking mechanism engaged with the aperture 110 of the tab 108.

FIG. 2 illustrates an example of an exploded view of a portion of a computing device chassis 220 having an example tab 108 consistent with the present disclosure. FIG. 2 may incorporate components from and/or have its illustrated components incorporated in the computing device chassis of FIGS. 1A-1D and/or system 366 of FIGS. 3A-3C.

The computing device chassis 220 may be a sealed enclosure formed from a plurality of portions 222-1 . . . 222-N. Each portion of the plurality of portions 222-1 . . . 222-N may include a panel of the computing device chassis 220 separable from the other portions of the computing device chassis 220. In some examples, each portion of the plurality of portions 222-1 . . . 222-N may include an extruded aluminum panel.

For example, a first portion 222-1 and a second portion 222-N may be joined, held, and/or sealed together utilizing a plurality of fasteners 224-1 . . . 224-N. For example, each of the fasteners 224-1 . . . 224-N may have its head exposed within a recess into an external surface of a second portion 222-N of the computing device chassis 220. The fasteners 224-1 . . . 224-N may connect the second portion 222-N of the computing device chassis 220 with the first portion 222-1 and hold the plurality of portions 222-1 . . . 222-N in a state of engagement with one another. That is, the fasteners 224-1 . . . 224-N may seal the plurality of portions 222-1 . . . 222-N of the computing device chassis 220 together. The fasteners 224-1 . . . 224-N may be visible and accessible by a visual inspection of the second portion 222-N of the computing device chassis 220, regardless of the position that a tab 228 is located in.

In addition to the fasteners 224-1 . . . 224-N, the computing device chassis 220 may include a hidden fastener 226. The hidden fastener 226 may include a fastener that also may connect the second portion 222-N of the computing device chassis 220 with the first portion 222-1. That is, in addition to the fasteners 224-1 . . . 224-N, the hidden fastener 226 may hold the plurality of portions 222-1 . . . 222-N in a state of engagement with one another. For example, the hidden fastener 226 may also seal and/or contribute to the seal between the plurality of portions 222-1 . . . 222-N of the computing device chassis 220. The hidden fastener 226, like the fasteners 224-1 . . . 224-N, may enter from the external surface of the second portion 222-N of the computing device chassis 220, through the second portion 222-N of the computing device chassis 220, and into a portion of the first portion 222-1 of the computing device chassis 220. The hidden fastener 226 may be visually and physically obstructed by the tab 228, depending on the position that the tab 228 is located in.

In order to access the interior and/or the internal contents of the computing device chassis 220, the plurality of portions 222-1 . . . 222-N may have to be separated to grant the access. As such, to unseal the computing device chassis 220 and gain access to the internal components, a user may have to unfasten the plurality of fasteners 224-1 . . . 224-N and the hidden fastener 226. Without unfastening both the plurality of fasteners 224-1 . . . 224-N and the hidden fastener 226, a user may not be able to separate the plurality of portions 222-1 . . . 222-N from one another and the computing device chassis 220 may remain sealed.

The computing device chassis 220 may include a cavity 230. The cavity 230 may be recessed into the external surface of the second portion 222-N of the computing device chassis 220. The cavity 230 may be separated from the interior of the computing device chassis and/or from the internal surface of the second portion 222-N of the computing device chassis 220. There may be no fluid communication between the interior of the computing device chassis 220 and the cavity 230.

The cavity 230 may include a floor 232. As used herein, floor is not intended to communicate an orientation of the floor 232 and/or the computing device chassis 220 relative to a reference surface such as the surface of the Earth. Rather a floor may include a portion of the external surface of the second portion 222-N of the computing device chassis 220 regardless of the orientation of the computing device chassis 220.

The floor 232 may be an external surface of the second portion 222-N of the computing device chassis 220. The cavity 230 may include a sidewall 234. The sidewall 234 may extend perpendicular to the floor 232 of the cavity 230 and define a depth or height of the cavity 230 relative to the floor 232.

The cavity 230 may include a protrusion 236. The protrusion 236 may include a protrusion perpendicular to the floor 232 of the cavity 230 extending into the cavity 230. For example, the protrusion 236 may include an extension of the external surface of the second portion 222-N that extends into the cavity 230. The protrusion 236 may form a tunnel that a fastener (e.g., fastener 224-N) may pass through and/or engage with. For example, the protrusion 236 may include a tunnel whose interior engages with threads of a fastener 224-4.

The cavity 230 may include a rail 238. For example, the cavity 230 may include a rail 238 along each of two opposing portions of the sidewall 234. The rail 238 may include a continuous recess into the opposing portions of the sidewall. Each rail 238 may extend longitudinally along a length of a respective portion of the sidewall 234.

The sidewall 234 may also include a notch and/or plurality of notches 240-1 . . . 240-N. A notch 240-1 . . . 240-N in the sidewall 234 may include a portion of the sidewall 234 that is cut out. The notch 240-1 . . . 240-N may include a portion of the sidewall 234 where the distance between opposing portions of the sidewall is widened. The notch 240-1 . . . 240-N may not extend along an entire longitudinal length of the sidewall 234. For example, the notch 240-1 . . . 240-N may be present in discrete locations of the sidewall 234 where the tab 228 is placed into the cavity 230 from the top during assembly.

The cavity 230 may include recesses 242-1 . . . 242-N. The recesses 242-1 . . . 242-N may include indents or divots into the floor 232 of the cavity 230. The recesses 242-1 . . . 242-N may not penetrate through the wall of the second portion 222-N of the computing device chassis 220. The recesses 242-1 . . . 242-N may be recessed to a depth sufficient to accommodate a catch 254-1 . . . 254-N flexed into the recesses 242-1 . . . 242-N responsive to the application of a force greater than a biasing force applied by the catches 254-1 . . . 254-N to a catch engaging aperture 262.

The computing device chassis 220 may include a raised structure. The raised structure may be a structure that is raised relative to the external surface of the second portion 222-N of the computing device chassis 220. The raised structure may include components layered over the external surface of the second portion 222-N of the computing device chassis 220.

For example, the raised structure may include an inner foot structure 248 and an outer foot structure 244. The inner foot structure 248 may include a molded plastic or aluminum foot structure to support and/or act as a substrate for the outer foot structure 244. The outer foot structure 244 may include a rubberized foot structure for contacting and/or providing grip on a surface where the computing device chassis 220 rests. The inner foot structure 248 and/or the outer foot structure 244 may support the computing device chassis 220 and act as an elevated pedestal to elevate the external surface of the second portion 222-N of the computing device chassis 220 off a surface that it is resting upon. As such, the inner foot structure 248 and/or the outer foot structure 244 act as an elevated pedestal to elevate the external surface of the second portion 222-N of the computing device chassis 220 off a surface that it is resting upon and provide airflow underneath the computing device chassis 220.

The inner foot structure 248 and the outer foot structure 244 may be attached to the external surface of the second portion 222-N of the computing device chassis 220. For example, the inner foot structure 248 and/or the outer foot structure 244 may be fastened to the external surface of the second portion 222-N of the computing device chassis 220 utilizing fasteners 224-4 and/or 224-N. For example, fasteners 224-4 and/or 224-N may be inserted through fastener holes 246-1 . . . 246-N through the inner foot structure 248 and the outer foot structure 244 and into the second portion 222-N of the computing device chassis 220. In an example, a fastener 224-N may be inserted through fastener holes 246-3 and 246-N and through and/or into protrusion 236 in the cavity 230.

The heads of fasteners 224-4 and/or 224-N may hold the inner foot structure 248 and the outer foot structure 244 in a state of engagement with the second portion 222-N of the computing device chassis 220. Additionally, or alternatively, the inner foot structure 248 and the outer foot structure 244 may be attached to the external surface of the second portion 222-N of the computing device chassis 220 utilizing a permanent adhesive bond between the inner foot structure 248, the outer foot structure 244, and/or the external surface of the second portion 222-N of the computing device chassis 220.

When the raised structure is attached to the external surface of the second portion 222-N of the computing device chassis 220, the raised structure may act as a roof of the cavity 230. As used herein, roof is not intended to communicate an orientation of the roof and/or the computing device chassis 220 relative to a reference surface such as the surface of the Earth. Rather a roof may include a portion of the internal surface of the raised structure of the computing device chassis 220 regardless of the orientation of the computing device chassis 220.

For example, the bottom or internal surface of the inner foot structure 248 may act as a roof of the cavity 230. In examples where the inner foot structure 248, the outer foot structure 244, and/or the external surface of the second portion 222-N of the computing device chassis 220 are attached with a permanent adhesive, the raised structure may remain attached to the second portion 222-N of the computing device chassis 220 even if the fasteners 224-4 and 224-N are removed. As such, once the tab 228 is inserted into the cavity 230 and the inner foot structure 248, the outer foot structure 244, and/or the external surface of the second portion 222-N of the computing device chassis 220 are attached with a permanent adhesive, the tab 228 may be permanently sealed within the cavity 230.

The computing device chassis 220 may include a detent clip 250. The detent clip 250 may be nested fully within the cavity 230. The detent clip 250 may include a detent clip aperture 252. The detent clip aperture 252 may fit around the protrusion 236 with the cavity 230. The detent clip aperture 252 may engage the protrusion 236 to maintain the position of the detent clip 250 within the cavity 230, prevent the removal of the detent clip 250 from the cavity 230, and to maintain alignment of a plurality of catches 254-1 . . . 254-N over corresponding recesses 242-1 . . . 242-N in the floor 232 of the cavity 230. The catches 254-1 . . . 254-N may include a biasing protrusion that is elevated from the surface of the detent clip 250. The catches 254-1 . . . 254-N may catch an object with a complementary geometry and hold the object in position over the catches 254-1 . . . 254-N until a force greater that a biasing force of the catches 254-1 . . . 254-N is applied to the object. The catches 254-1 . . . 254-N may be flexible and able, with application of a force greater than the biasing force, to be flexed down into a complementary recess 242-1 . . . 242-N allowing the object with the complementary geometry to escape the catch 254-1 . . . 254-N and travel freely.

The computing device chassis 220 may include a tab 228. The tab 228 may include an aperture 256. The aperture 256 may include a window or opening through the tab 228. Objects located under the tab 228 (e.g., on the external surface of the second portion 222-N of the computing device chassis 220) may be accessed through the aperture 256 when the aperture 256 is aligned over the object.

The tab 228 may also include a protrusion channel 258. The protrusion channel 258 may be an elongate channel running a portion of the length of the tab 228. The protrusion channel 258 may be elongate oval shaped and run a length of the tab 228 that allows the tab 228 to be slid between fully nested and fully extended without interference of the protrusion 236 within the cavity 230.

The tab 228 may include a rail engaging extension 260-1 . . . 260-N. The rail engaging extension 260-1 . . . 260-N may include a portion of the tab 228 body where the tab 228 is wider than a remainder of the tab 228 body. The rail engaging extension 260-1 . . . 260-N may extend from the side of the tab 228. The rail engaging extension 260-1 . . . 260-N may be dimensioned to fit and/or travel within the rail 238 while the main body of the tab 228 travels within the cavity 230.

The tab 228 may include a catch engaging aperture 262. The catch engaging aperture 262 may be an aperture located proximate a distal terminus of the elongate body of tab 228. The catch engaging aperture 262 may, for example, be located in or through the body of the tab 228 at a location on the tab 228 body between the protrusion channel 258 and an end of the elongate body of the tab 228.

The tab 228 may be positioned within the cavity 230. For example, the tab 228 may be positioned within the cavity 230 such that the protrusion 236 is positioned through and/or within the protrusion channel 258 of the tab 228. In order to fit the tab 228 within the cavity 230, the raised structure may not yet be attached to the computing device chassis 220. The rail engaging extensions 260-1 . . . 260-N of the tab 228 may be aligned with the corresponding notches 240-1 . . . 240-N in the sidewall 234. The tab 228 may be pressed into the cavity 230 toward the floor 232 of the cavity 230. The rail engaging extensions 260-1 . . . 260-N of the tab 228 may travel within corresponding notches 240-1 . . . 240-N in the sidewall 234 as the tab 228 descends to the floor 232 of the cavity 230. The tab 228 may be pressed in until the rail engaging extensions 260-1 . . . 260-N enter into the rail 238 portion in the sidewall 234. Once the tab 228 is positioned within the cavity 230 and/or the rail engaging extensions 260-1 . . . 260-N enter into the rail 238 portion in the sidewall 234 of the cavity, the tab 228 may be sealed within the cavity 230 by fastening and/or adhering the raised structure to the second portion 222-N of the computing device chassis 220.

Once inserted within the cavity 230, the tab 228 may be slidable to various positions within the cavity 230. For example, the tab 228 may slide within the cavity 230 along an axis that runs parallel to the recessed external surface of the second portion 222-N of the computing device chassis 220. The rail engaging extensions 260-1 . . . 260-N may slide within the rail 238 guiding the movement of the tab 228 and/or preventing movement of the tab 228 outside of the axis of travel. The axis of travel of the tab 228 may be parallel to the floor 232 of the cavity 230 and guided by the rail 238.

As such, the tab 228 may slide into and/or out of the cavity 230 along the axis of travel parallel to the floor 232 of the cavity 230. The rail engaging extensions 260-1 . . . 260-N may prevent the tab 228 from being entirely inserted into and/or totally removed from the cavity 230. For example, the rail engaging extensions 260-1 . . . 260-N may stop or block travel of the tab 228 when it hits stops within the rail 238 that are designed to limit length of travel by obstructing travel within the rail beyond the stop. Further, the protrusion channel 258 may prevent the tab 228 from being entirely inserted into and/or totally removed from the cavity 230 by stopping travel of the tab 228 when the wall of the protrusion channel 258 contacts the protrusion 236.

The tab 228 may be positioned over the detent clip 250 within the cavity 230. As the tab 228 is slid among and/or between a plurality of positions within the cavity 230, the catch engaging aperture 262 may engage with the catches 254-1 . . . 254-N along its travel. The tab 228 may be slidable between a plurality of positions. In a first position, the tab 228 may be positioned within the cavity 230 such that it exposes the hidden fastener 226, for example, through the aperture 256.

Additionally, the tab 228 may be slid, the rail engaging extensions 260-1 . . . 260-N traveling within the rail 238, further out of the cavity from the first position to a second position. In the second position, the solid portion of the body of the tab 228 may visually and/or physically obstruct or lay over the hidden fastener 226. In the second position, the aperture 256 may be advanced out of the cavity and extend beyond the perimeter of the computing device chassis 220. In the second position, a lock may be engaged with the aperture 256 and locked such that the tab 228 is prevented from returning to the first position. In the second position, the tab 228 may be advanced out of the cavity 230 to the extent that the rail engaging extensions 260-1 . . . 260-N traveling within the rail 238 have reached a stop nearest the opening of the cavity 230 and/or the protrusion 236 has reached a wall of the protrusion channel 258 nearest the back wall of the cavity 230.

In the second position, the catch engaging aperture 262 may be aligned over and/or engaged by the catch 254-N of the detent clip 250 nearest to the opening of the cavity 230. As such, the catch 254-N may apply a biasing force to keep the tab 228 in the second position. The biasing force may be applied by the catch 254-N to the engaging aperture 262 until a force greater than the biasing force is applied to the tab 228. Once the greater force is applied, the catch 254-N may be forced out of the catch engaging aperture 262 and down into a corresponding recess 242-N allowing the tab 228 to slide freely within the cavity 230.

The tab 228 may be slid, the rail engaging extensions 260-1 . . . 260-N traveling within the rail 238, further into the cavity. For example, the tab 228 may be slide from the first position to a third position and/or from the second position to the third position.

In the third position, the tab 228 may be in a fully nested position where the tab 228 is retracted to its furthest point within the cavity 230. In the third position a portion of the terminus 264 of the tab 228 may be accessible from outside of the cavity 230. In the third position, the solid portion of the body of the tab 228 and/or the terminus 264 of the tab 228 may visually and/or physically obstruct or lay over the hidden fastener 226. In the third position, the aperture 256 may be nested entirely within the cavity 230 and located in a position within the cavity 230 that is posterior to the hidden fastener 226. In the third position, the tab 228 may be nested within the cavity 230 to the extent that the rail engaging extensions 260-1 . . . 260-N traveling within the rail 238 have reached a stop located furthest from the opening of the cavity 230. Further, the tab 228 may be nested within the cavity 230 to the extent that the protrusion 236 has reached a wall of the protrusion channel 258 nearest the opening of the cavity 230.

In the third position, the catch engaging aperture 262 may be aligned over and/or engaged by the catch 254-1 of the detent clip 250 furthest from the opening of the cavity 230. As such, the catch 254-1 may apply a biasing force to keep the tab 228 in the third position by remaining engaged with the catch engaging aperture 262 until a force greater than the biasing force is applied to the tab 228. Once the greater force is applied the catch 254-1 may be flexed downward and forced out of the catch engaging aperture 262 and into a corresponding recess 242-1. By disengaging the catch engaging aperture 262 from the catch 254-1, the tab 228 may be freed from the biasing force of the catch 254-1 and be able to slide freely within the cavity 230.

In the third position, the terminus 264 of the tab 228 may be positioned within the opening to the cavity 230. For example, the terminus 264 of the tab 228 may be positioned within the opening to the cavity 230 such that it provides a camouflaged appearance settled flush with the surrounding surfaces of the external surface of the second portion 222-N of the computing device chassis 220 and/or the raised structure attached to the external surface of the second portion 222-N of the computing device chassis 220.

FIG. 3A illustrates an example of a partially exploded view of a portion of a system 366 having an example tab 376 consistent with the present disclosure wherein the tab 376 is disposed in a first position. FIGS. 3A-3C may illustrate examples of the system 366 with its constituent components in different positions or orientations. FIGS. 3A-30 may incorporate components from and/or have their illustrated components incorporated in the computing device chassis 100 of FIGS. 1A-1D and/or computing device chassis 220 of FIG. 2.

The system 366 may include a computing device chassis 372. The computing device chassis 372 may be a computational component enclosure built from a plurality of computing device chassis portions 368-1 . . . 368-N. The portions 368-1 . . . 368-N may include a first portion 368-1 and a second portion 368-N, although any number of portions may be utilized to form the computing device chassis 372.

The plurality of computing device chassis portions 368-1 . . . 368-N may be reversibly joined together via a plurality of fasteners. For example, fasteners 370-1 . . . 370-N may join the computing device chassis portions 368-1...368-N together to form a sealed enclosure to act as a computing device chassis 372. In addition to and/or instead of fasteners 370-1 . . . 370-N, the plurality of computing device chassis portions 368-1 . . . 368-N may be reversibly joined together via a hidden fastener 398 or hidden fasteners.

The hidden fastener 398, not visible in FIG. 3A, may be located within and/or at the mouth or entrance to the cavity 374. The hidden fastener 398 may be visually and/or physically obstructed by an object located within and/or at the mouth of the cavity 374. However, in order to separate the plurality of computing device chassis portions 368-1 . . . 368-N and gain access to the interior of the computing device chassis 372, the hidden fastener 398 may need to be removed and/or unfastened. That is, access to the interior of the computing device chassis 372 involves removal of the hidden fastener 398.

The system 366 may include a raised structure 394-1 . . . 394-N. The raised structure 394-1 . . . 394-N may be attachable to an external surface 398 of the second computing device chassis portion 368-N of the computing device chassis 372. The raised structure 394-1 . . . 394-N may be attachable to an external surface 398 of the second computing device chassis portion 368-N of the computing device chassis 372 via a fastener. Additionally or alternatively, the raised structure 394-1 . . . 394-N may be attachable to an external surface 398 of the second computing device chassis portion 368-N of the computing device chassis 372 via a permanent adhesive bond with the external surface 396 of the second computing device chassis portion 368-N of the computing device chassis 372. The second computing device chassis portion 368-N of the computing device chassis 372 may be a bottom plate of the computing device chassis 372. The raised structure 394-1 . . . 394-N may, therefore, be feet or pedestals for the computing device chassis 372.

The system 366 may include a cavity 372 recessed into the external surface 396 of the second computing device chassis portion 368-N of the computing device chassis 372. As such, when the raised structure 394-1 . . . 394-N is attached to an external surface 396 of the second computing device chassis portion 368-N of the computing device chassis 372, an internal surface of the raised structure 394-1 . . . 394-N may serve as a roof over the cavity 374. That is, the internal surface of the raised structure 394-1 . . . 394-N may prevent the removal of objects upward out of the cavity 372.

Likewise, a recessed portion of the external surface 396 of the second computing device chassis portion 368-N may serve as a floor 380 under the cavity 374. The floor 380 may prevent the removal of objects downward out of the cavity 374. As such, the cavity 374 includes a floor 380 and a roof and is physically separated and wholly distinct from the interior of the computing device chassis 372 housing computational components. That is, the cavity 374 may be external to the interior of the computing device chassis 372 where computational components are to be housed and no communicating openings or channels may exist between the two. As such, the interior of the computing device chassis 372 may not be contaminated by any contaminates that enter the cavity 374.

The cavity 374 may include a protrusion 384 that protrudes up from the floor 380 of the cavity 374 and into the hollow of the cavity 374. The protrusion 384 may include an aperture therethrough to accommodate a fastener entering from and/or holding in place the raised structure 394-1 . . . 394-N. The system 366 may include a detent clip 390 on the floor 380 of the cavity 374. The detent clip 390 may include an aperture that engages around the protrusion 384.

The detent clip 390 may include catches 386-1 . . . 386-N. The catches 386-1 . . . 386-N may include biasing protrusions such as catches 386-1 . . . 386-N that are elevated from the surface of the detent clip 390 and may catch an object with a complementary geometry. The catches 386-1 . . . 386-N may hold the object in a position over the catches 386-1 . . . 386-N until a force greater that a biasing force of the catches 386-1 . . . 386-N is applied to the object. The catches 386-1 . . . 386-N may be flexible and able, with application of a force greater than the biasing force, to be flexed down into a complementary recess within the floor 380 of the cavity 374. When flexed downward, engagement between the catches 386-1 . . . 386-N and the object may be lost, and the object may be allowed to escape the biasing force of the catches 386-1 . . . 386-N to travel freely.

The system 366 may include a tab 376. The tab 376 may be located in the cavity 374 over the detent clip 390. The tab 376 may include a protrusion channel 399. The protrusion channel 399 may include a channel through the tab 376 dimensioned to allow the protrusion 384 to pass through and travel within the body of the tab 376 as the tab 376 is slid between positions within the cavity 374.

The tab 376 may include a catch engaging aperture 392. That catch engaging aperture 392 may have a complementary geometry to the catches 386-1 . . . 386-N such that the catches 386-1 . . . 386-N may engage the catch engaging aperture 392 when it aligns over the catches 386-1 . . . 386-N as the tab 376 is slid within the channel 376.

The tab 376 may also include an aperture 378. The aperture 378 may include a window through the body of the tab 376. The aperture 378 may allow visual and/or physical access to objects and/or portions of the computing device chassis 372 that are located beneath the tab 376 within the cavity 374.

The tab 376 may be an elongate body. The tab 376 may include a first terminus 382-1 and a second terminus 382-2 that is opposite the first terminus 382-1. The first terminus 382-1 may include a geometry that visually blends into and may sit flush with the geometry of the second computing device chassis portion 368-N and/or the raised structure 394-1 . . . 394-N when the tab 376 is fully nested within the cavity 374.

The tab 376 of system 366 may be slidable within the cavity 374. For example, the tab 376 may be slidable within the cavity 374 between the recessed external surface of the second computing device chassis portion 368-N (e.g., the floor 380 of cavity 374) and the internal surface of the raised structure 394-1 . . . 394-N (e.g., the roof of the cavity 374). The tab 376 may be slidable within the cavity 374 to travel along an axis running parallel to the floor 380 of cavity 374. Movement along the axis may cause the tab 376 to enter deeper (e.g., further toward a rear of the cavity 374) into the cavity 374 through the mouth of the cavity 374 or to slide further out of the cavity 374 through the mouth of the cavity 374. The tab 376 may be slidable between and/or among a plurality of positions.

For example, the tab 376 may be slidable to a first position illustrated in FIG. 3A. In the first position, the tab 376 may retracted to its fullest allotted extent within the cavity 374. For example, the tab 376 may be pushed back into the cavity 374 as far as it may reach until a portion of the tab 376 encounters a stop and/or a rear wall of the cavity 374.

In the first position, the tab 376 may obstruct access to and/or visibility of the hidden fastener 398. For example, the hidden fastener 398 may be covered by the body of the tab 376 and/or by the first terminus 382-1 of the tab 376. The aperture 378 of the tab 376 may be located between the hidden fastener 398 and the protrusion 384. The aperture 378 may be aligned over a portion of the floor 380 in the cavity 374. The portion of the floor 380 may not be the portion of the floor 380 where the hidden fastener 398 is located. A wall of the protrusion channel 399 of the tab 376 nearest the first terminus 382-1 may be engaged against the protrusion 384. The second terminus 382-2 may be resting against and/or proximate to the rear wall of the cavity 374.

In the first position, the catch engaging aperture 392 may be located over and/or engaged by a catch 386-2 of the detent clip 390. The catch 386-2 may protrude into the catch engaging aperture 392 to hold the tab 376 in the first position. The tab 376 may be in the first position until a force greater than a biasing force exerted by the catch 386-2 is exerted on the tab 376. As such, the first position may be an unlocked and hidden position for hiding the hidden fastener 398 but leaving the tab 376 unlocked to be slid to a service position whenever needed without unlocking a lock mechanism.

FIG. 3B illustrates an example of a partially exploded view of a portion of a system 366 having an example tab 376 consistent with the present disclosure wherein the tab 376 is disposed in a second position. FIG, 38 includes an arrow indicating a direction of travel of the tab 376 from FIG. 3A to FIG. 3B. The tab 376 may be slidable to a second position illustrated in FIG. 3B. In the second position, the tab 376 may be slid partially out of the cavity 374 away from the back wall of the cavity 374 and toward the opening of the cavity 374. In the second position, the tab 376 may extend a first distance outside of the cavity 374. For example, the first terminus 382-1 of the tab 376 may extend outside of the cavity 374 and/or outside the perimeter of the computing device chassis 372.

In the second position, the aperture 378 of the tab 376 may be positioned in the position occupied by the first terminus 382-1 when the tab 376 is in the first position. As such, the aperture 378 through the tab 376 may be positioned over and/or aligned with the hidden fastener 398. That is, the hidden fastener 398 may be visible and/or physically accessible through the aperture 378 of the tab 376.

As described above, in order to gain access to the interior of the computing device chassis 372, the plurality of computing device chassis portions 368-1 . . . 368-N may first be separated. Since the hidden fastener 398 may hold a portion of the computing device chassis portions 368-1 . . . 368-N together, the hidden fastener 398 may need to be removed or unfastened in order to gain access to the interior of the computing device chassis 372. The tab 376 may need to be positioned in the second position illustrated in FIG. 3B in order for the hidden fastener 398 to be located and/or unfastened through the aperture 378.

In all positions other than the second position, the tab 376 may obstruct the hidden fastener 398 and prevent the computing device chassis portions 368-1 . . . 368-N from separation by hiding the hidden fastener 398 and physically blocking its manipulation and/or removal. As such the second position may be a servicing position for removing the hidden fastener 398 to perform servicing, repairing, replacing, or removing computational components from the interior of the computing device chassis 372.

The tab 376 may be slidable to a second position illustrated in FIG. 3B. In the second position, the tab 376 may be slid partially out of the cavity 374 away from the back wall of the cavity 374 and toward the opening of the cavity 374. In the second position, the tab 376 may extend a first distance outside of the cavity 374. For example, the first terminus 382-1 of the tab 376 may extend outside of the cavity 374 and/or outside the perimeter of the computing device chassis 372.

FIG. 3C illustrates an example of a partially exploded view of a portion of a system 366 having an example tab 376 consistent with the present disclosure wherein the tab 376 is disposed in a third position. FIG. 3C includes an arrow indicating a direction of travel of the tab 376 from FIG. 3B to FIG. 3C. The tab 376 may be slidable to a third position illustrated in FIG. 30. In the third position, the tab 376 may be slid to its furthest extent out of the cavity 374 away from the back wall of the cavity 374 and toward the opening of the cavity 374. For example, the tab 376 may be slid out of the cavity 374 until a portion of the protrusion channel 399 nearest the second terminus 382-2 makes contact with the protrusion 384, stopping the travel of the tab 376.

In the third position, the tab 376 may extend a second distance outside of the cavity 374. The second distance outside of the cavity may be greater that the first distance outside of the cavity that the tab 376 extends when in the second position. For example, in the third position, the first terminus 382-1 of the tab 376 may extend outside of the cavity 374 and/or outside the perimeter of the computing device chassis 372. Further, a portion of the body of the tab 376 including the aperture 378 may extend outside of the cavity 374 and/or outside the perimeter of the computing device chassis 372. As such, the aperture 378 may be exposed to engagement by a locking mechanism.

For example, the aperture 378 of the tab 376 may be engaged by a cable or a shank of a lock passing through the aperture 378. When the aperture 378 is engaged by the locking mechanism, the presence of the locking mechanism in engagement with the aperture 378 may physically prevent or block the tab 376 form being returned or retracted into the cavity 374 from the third position. As such, the tab 376 may be in a locked position where the tab 376 is locked into the third position and where a second position and/or first position cannot be achieved without disengaging the locking mechanism form the aperture 378.

In the third position, the tab 376 may obstruct visual and/or physical access to the hidden fastener 398 as the solid portion of the elongate body of the tab 376 may be positioned over the hidden fastener 398. As such, when the tab 376 is locked in the third position, the hidden fastener 398 may be locked beneath the tab 376, thereby locking the computing device chassis portions 368-1 . . . 368-N together by preventing removal of the hidden fastener 398.

In the third position, the catch engaging aperture 392 may be located over and/or engaged by a catch 386-1 of the detent clip 390. The catch 386-1 may protrude into the catch engaging aperture 392. The catch 386-1 may hold the tab 376 in the third position until a force greater than a biasing force exerted by the catch 386-1 is exerted on the tab 376. Once the greater force is exerted, the catch 386-1 may flex out of engagement with the catch engaging aperture 392 and free the tab 376 for movement within the cavity 374.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG, 2. As used herein, the designator ‘N’, particularly with respect to reference numerals in the drawings, indicates that a number of the particular feature so designated can be included with examples of the present disclosure. The designators can represent the same or different numbers of the particular features. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A computing device chassis, comprising:
a fastener to seal the computing device chassis; and
a tab attached to an external surface of the computing device chassis and slidable over the external surface of the computing device chassis between:
a first position, exposing the fastener beneath the tab, and
a second position, obstructing access to the fastener beneath the tab and exposing a lock-engaging portion of the tab, wherein engagement of the lock-engaging portion of the tab with a locking mechanism blocks the tab from returning to the first position.

2. The computing device chassis of claim 1, wherein the fastener is visually hidden by the tab unless the tab is in the first position.

3. The computing device chassis of claim 1, wherein the device includes:
a foot structure attached to the external surface of the computing device chassis; and
a cavity between the foot structure and the external surface of the computing device chassis.

4. The computing device chassis of claim 3, wherein the tab is slidable within the cavity and the lock-engaging portion of the tab extends outside of the cavity when the tab is in the second position.

5. The computing device chassis of claim 3, wherein the lock-engaging portion of the tab includes an aperture through the tab configured to accommodate a padlock shank, wherein the padlock shank blocks the tab from recessing within the cavity when inserted within the aperture.

6. The computing device chassis of claim 5, wherein the aperture of the tab is aligned over the fastener when the tab is in the first position.

7. A computing device chassis, comprising:
a fastener to seal the computing device chassis;
a raised structure attachable to the computing device chassis; and
a tab slidable within a cavity between the raised structure and the computing device chassis, wherein the tab is slidable between:
a first position, wherein the tab exposes the fastener when in the first position, and
a second position, wherein the tab, when in the second position, obstructs access to the fastener and exposes a lock-engaging portion of the tab engageable by a lock to prevent the tab from returning to the first position.

8. The computing device chassis of claim 7, wherein the cavity contains a detent clip configured to engage a catch engaging aperture of the tab to hold the tab in the second position.

9. The computing device chassis of claim 7, wherein the tab is slidable to a third position, wherein the tab is fully recessed within the cavity and obstructs access to the fastener.

10. The computing device chassis of claim 9, wherein the cavity contains a detent clip configured to engage a catch engaging aperture of the tab to hold the tab in the third position.

11. The computing device chassis of claim 7, wherein the tab includes a channel and the computing device chassis includes a protrusion into the cavity configured to fit within the channel and block the tab from removal from the cavity.

12. A system, comprising:
a computing device chassis including:
first portion and a second portion, wherein the first portion is reversibly joinable to the second portion via a fastener to form an enclosure;
a raised structure attachable to an external surface of the first portion of the computing device chassis; and
a tab slidable within a cavity between the external surface of the first portion of the computing device chassis and the raised structure, wherein the tab is slidable between:
a first position wherein the tab is retracted within the cavity and obstructs access to the fastener,
a second position wherein the tab extends a first distance outside of the cavity, wherein an aperture through the tab is aligned over and provides access to the fastener, and
a third position wherein the tab extends a second distance outside of the cavity and obstructs access to the fastener, and wherein the tab is lockable in the third position.

13. The system of claim 12, wherein the cavity is external to an interior of the computing device chassis where computational components are housed.

14. The system of claim 12, wherein the raised structure includes a foot attached to the external surface of the computing device chassis with a permanent adhesive.

15. The system of claim 12, wherein access to the interior of the computing device chassis involves removal of the fastener.
